(19) United States
(12) Patent Application Publication
(10) Pub. No.: US 2014/0042798 A1
(43) Pub. Date: Feb. 13, 2014

(54) COMPOSITE BICYCLE RIM

(71) Applicants: Toru IWAI, Osaka (JP); Yoshikazu KASHIMOTO, Osaka (JP)

(72) Inventors: Toru IWAI, Osaka (JP); Yoshikazu KASHIMOTO, Osaka (JP)

(73) Assignee: SHIMANO INC., Osaka (JP)

(21) Appl. No.: 13/570,667

(22) Filed: Aug. 9, 2012

(51) Int. Cl. B60B 5/02; B26D 3/00

(52) U.S. Cl. 301/95.102; 219/121.85; 83/861

(57) ABSTRACT

A composite bicycle rim includes a first annular side wall, a second annular side wall and an annular bridge. The first annular side wall has a first braking contact portion. The second annular side wall has a second braking contact portion. The annular bridge extends between the first and second annular side walls. At least one of the first and second braking contact portions has a plurality of exposed hard particles partially embedded in a non-metallic layer. The exposed hard particles are partially exposed on an outermost surface of the at least one of the first and second braking contact portions.

### BACKGROUND

1. Field of the Invention

This invention generally relates to a composite bicycle rim. More specifically, the present invention relates to a composite bicycle rim with an improved braking surface.

2. Background Information

There are many different types of bicycle wheels, which are currently available on the market. Most bicycle wheels have a hub portion, a plurality of spokes and an annular rim. The hub portion is attached to a part of the frame of the bicycle for relative rotation. The inner ends of the spokes are coupled to the hub portion and extend outwardly from the hub portion. The annular rim is coupled to the outer ends of the spokes and has an outer portion for supporting a pneumatic tire thereon. Typically, the spokes of the bicycle wheel are thin metal wire spokes.

In the past, most conventional bicycle rims were constructed of various metal materials. However, in more recent years, the bicycle rims have been constructed using composite materials to make them more lightweight. For example, in U.S. Pat. No. 7,464,994, a composite bicycle rim has been proposed that has a continuously extending resin material covering a portion of an annular metallic rim member. In U.S. Pat. No. 5,104,199, a composite bicycle rim has been proposed that has a molded body attached to a rim hoop. Also composite bicycle rims have been proposed that are mainly formed of woven carbon fibers that are impregnated with a thermosetting resin. One example of a composite bicycle rim that is made primarily of woven carbon fibers is disclosed in U.S. Pat. No. 7,614,706.

### SUMMARY

Generally, the present disclosure is directed to various features of a composite bicycle rim that has an improved braking surface.

In one embodiment, a composite bicycle rim is provided that comprises a first annular side wall, a second annular side wall and an annular bridge. The first annular side wall includes a first braking contact portion. The second annular side wall includes a second braking contact portion. The annular bridge extends between the first and second annular side walls. At least one of the first and second braking contact portions has a plurality of exposed hard particles partially embedded in a non-metallic layer. The exposed hard particles are partially exposed on an outermost surface of the at least one of the first and second braking contact portions.

Other objects, features, aspects and advantages of the disclosed composite bicycle rim will become apparent to those skilled in the art from the following detailed description, which, taken in conjunction with the annexed drawings, discloses preferred embodiments.

### BRIEF DESCRIPTION OF THE DRAWINGS

Referring now to the attached drawings which form a part of this original disclosure:

FIG. 1 is a side elevational view of a composite bicycle wheel that is equipped with a composite bicycle rim made of a composite material in accordance with a first illustrated embodiment;

FIG. 2 is an enlarged, partial cross-sectional view of the composite bicycle rim illustrated in FIG. 1 as seen along section line 2-2 in FIG. 1;

FIG. 3 is a further enlarged, partial cross-sectional view of a first braking contact portion of the bicycle rim illustrated in FIG. 2;

FIG. 4 is an enlarged, partial side elevational view of the first braking contact portion of the bicycle rim illustrated in FIG. 1;

FIG. 5 is a flowchart showing a process for forming the first braking contact portion of the composite bicycle rim;

FIG. 6 is an enlarged, partial cross-sectional view of portions of a fiberglass composite layer and a carbon composite layer that are placed in a mold at a time prior to molding for forming the composite bicycle rim illustrated in FIG. 1;

FIG. 7 is an enlarged, partial cross-sectional view of portions of an epoxy layer, the fiberglass composite layer and the carbon composite layer at a time prior to removing a portion of the epoxy layer after molding for forming the composite bicycle rim illustrated in FIG. 1;

FIG. 8 is an enlarged, partial cross-sectional view of a portion the first braking contact portion of the composite bicycle rim illustrated in FIG. 1 after removing a portion of the epoxy layer to partially expose the hard particles; and

FIG. 9 is an enlarged, partial cross-sectional view of a composite bicycle rim in accordance with a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

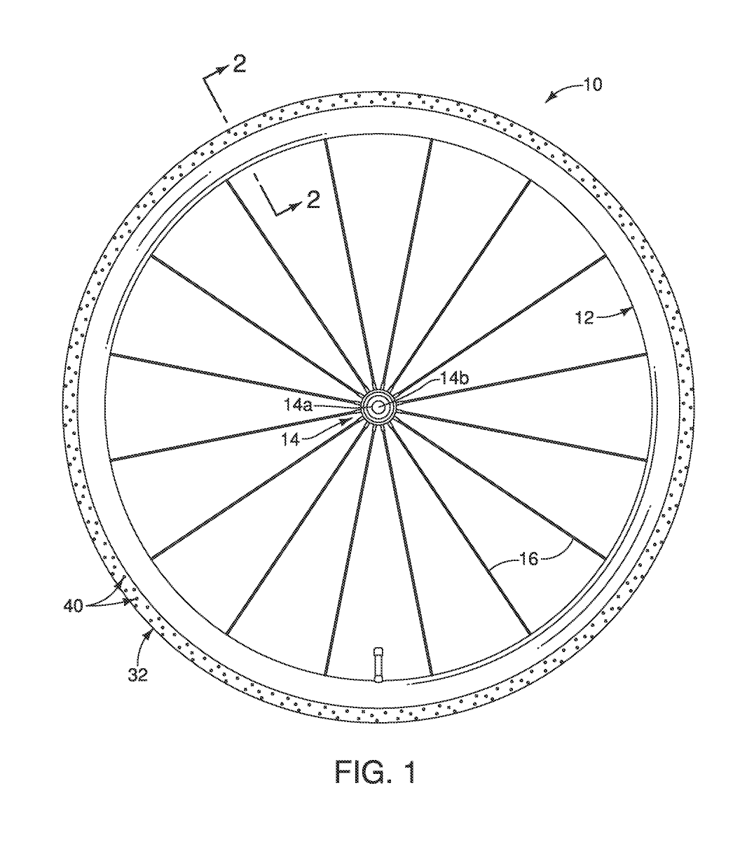

Referring initially to FIG. 1, a bicycle wheel 10 is illustrated in accordance with a first embodiment. The bicycle wheel 10 basically includes a composite bicycle rim 12, a center hub 14 and a plurality of spokes 16. As seen in FIG. 1, the composite bicycle rim 12 is an annular member that is designed for rotation about a center rotational axis formed by a hub axle 14b of the center hub 14. The spokes 16 interconnect the composite bicycle rim 12 and the center hub 14 together in a conventional manner. A pneumatic tire (not shown) is secured to the outer surface of the composite bicycle rim 12 in a conventional manner.

First, the center hub 14 will be briefly described. The center hub 14 includes a hub shell 14a that is rotatably mounted on the hub axle 14b via a pair of bearing units (not shown). The center hub 14 can be any type of bicycle hub that can be used with the composite bicycle rim 12. In other words, the precise construction of the center hub 14 is not important to the construction of the bicycle wheel 10. Thus, the center hub 14 will not be discussed and/or illustrated in further detail herein. Also, while a front hub is illustrated, the composite bicycle rim 12 can also be used with a rear hub to form a rear wheel as needed and/or desired.

Likewise, the precise construction of the spokes 16 is not important to the construction of the composite bicycle wheel 10. The spokes 16 can be any type of spokes or other type of connecting device (e.g., a metal spoke, a composite spoke, a disc-shaped connecting member, etc.). Thus, the spokes 16 will not be discussed and/or illustrated in detail herein. In the first illustrated embodiment, the spokes 16 are metal, radial tension spokes. The spokes 16 connect the center hub 14 to the composite bicycle rim 12, with one or both ends of each of the spokes 16 being provided with a spoke nipple. In the first illustrated embodiment, for example, sixteen radial spokes 16 are coupled to the composite bicycle rim 12 at equally spaced circumferential locations as seen in FIG. 1. Alternatively, eight of the spokes 16 may extend from the center of the composite bicycle rim 12 to one side of the center hub 14, while the other eight spokes 16 may extend from the center of the composite bicycle rim 12 to the other side of the center hub 14. Of course, it will be apparent to those skilled in the art from this disclosure that the composite bicycle rim 12 could be modified to accommodate different spoking arrangements (e.g., all tangential spokes, some tangential spokes and some radial spokes, etc.) without departing from the scope of the present invention. Also, it will also be apparent to those skilled in the art from this disclosure that the composite bicycle rim 12 could use be modified to accommodate fewer or more than sixteen spokes if needed and/or desired. In any case, the spokes 16 are preferably coupled to the composite bicycle rim 12 in a circumferentially spaced arrangement.

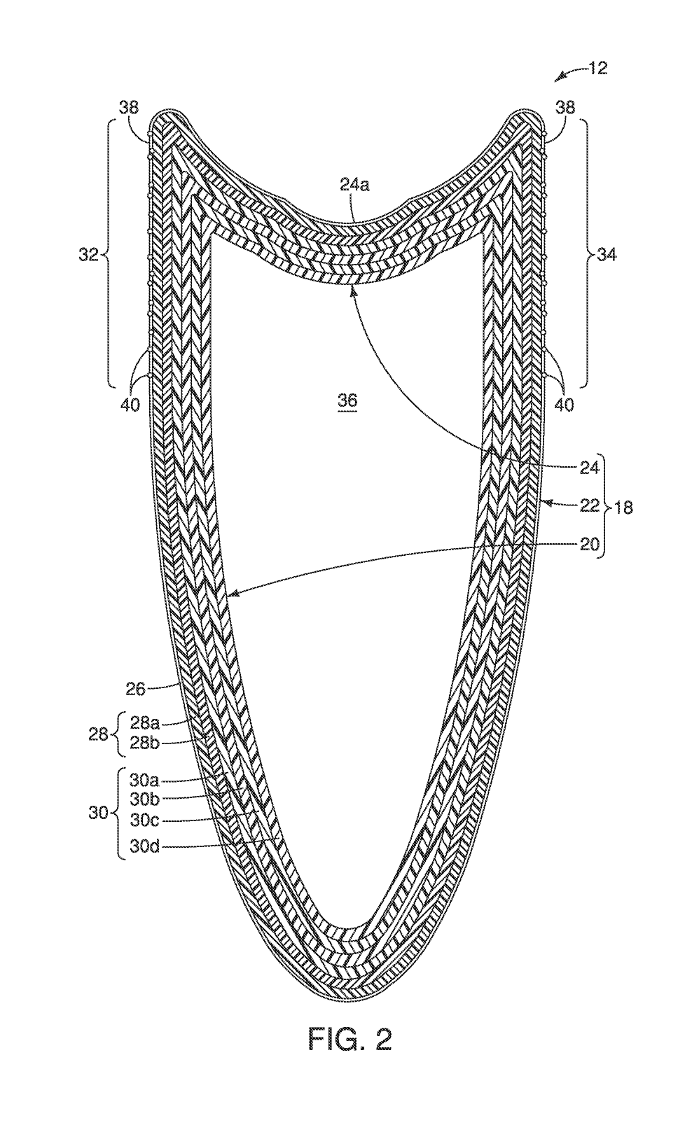

Turning now to FIG. 2, the construction of the composite bicycle rim 12 will now be discussed in more detail. In the first illustrated embodiment, the composite bicycle rim 12 is a completely non-metallic composite member. The composite bicycle rim 12 basically includes a main body 18 that has a first annular side wall 20, a second annular side wall 22 and an annular bridge 24. As seen in FIG. 2, in the first illustrated embodiment, the first and second annular side walls 20 and 22 and the annular bridge 24 are basically formed by laminating an epoxy layer 26, a fiberglass composite layer 28 and a carbon composite layer 30. The fiberglass composite layer 28 and the carbon composite layer 30 are examples of non-metallic layers. It will be apparent to those skilled in the art from this disclosure that the layers 28 and 30 of the composite bicycle rim 12 are not limited to these non-metallic materials. Moreover, the composite bicycle rim 12 does not need to be a completely non-metallic composite member if needed and/or desired.

The epoxy layer 26 defines an outermost surface of the main body 18. The fiberglass composite layer 28 is arranged immediately below the epoxy layer 26. In other word, the epoxy layer 26 is disposed directly on the fiberglass composite layer 28. In the first illustrated embodiment, the fiberglass composite layer 28 is formed of a first fiberglass sheet 28a and a second fiberglass sheet 28b. Each of the first and second fiberglass sheets 28a and 28b includes unidirectional reinforcing glass fibers that are impregnated with an epoxy resin. The first and second fiberglass sheets 28a and 28b are laminated so that the first and second fiberglass sheets 28a and 28b have directions of the unidirectional reinforcing glass fibers that are different from each other. For example, the first and second fiberglass sheets 28a and 28b are laminated so as to form layers of unidirectional glass fibers that cross each other. It will be apparent to those skilled in the art from this disclosure that the fiberglass composite layer 28 is not limited to being formed of only two fiberglass sheets. Rather, fewer or more of the fiberglass sheets can be used to form the fiberglass composite layer 28 if needed and/or desired. Moreover, the fiberglass composite layer 28 could be eliminated such that the main body 18 or the composite bicycle rim 12 is primarily formed by the carbon composite layer 30 with the epoxy layer 26 formed of the outermost surface of the carbon composite layer 30. As explained below, epoxy resin from the first fiberglass sheet 28a forms the epoxy layer 26 during the molding process such that the epoxy layer 26 and the fiberglass composite layer 28 form a non-metallic layer of the carbon composite layer 30.

The carbon composite layer 30 is arranged immediately below the fiberglass composite layer 28. In other word, the carbon composite layer 28 is disposed directly on the fiberglass composite layer 28. Also, an interior surface of the carbon composite layer 30 defines an annular interior space or area 36, which can be empty or filled with a foam material or the like. The carbon composite layer 30 is formed of a first carbon fiber sheet 30a, a second carbon fiber sheet 30b, a third carbon fiber sheet 30c and a fourth carbon fiber sheet 30d. Each of the first, second, third and fourth carbon fiber sheets 30a, 30b, 30c and 30d includes unidirectional reinforcing carbon fibers that are impregnated with an epoxy resin. The first, second, third and fourth carbon fiber sheets 30a, 30b, 30c and 30d are laminated so that two adjacent ones of the first, second, third and fourth carbon fiber sheets 30a, 30b, 30c and 30d have directions of the unidirectional reinforcing carbon fibers that are different each other. For example, the first, second, third and fourth carbon fiber sheets 30a, 30b, 30c and 30d are laminated so that the two adjacent ones of the first, second, third and fourth carbon fiber sheets 30a, 30b, 30c and 30d have unidirectional carbon fibers that cross each other. It will be apparent to those skilled in the art from this disclosure that the carbon composite layer 30 is not limited to being formed of four carbon fiber sheets. Rather, fewer or more of the carbon fiber sheets can be used to form the carbon composite layer 30 if needed and/or desired.

The first annular side wall 20 has a first braking contact portion 32 that is located adjacent a first end of the annular bridge 24. The second annular side wall 22 has a second braking contact portion 34 that is located adjacent a second end of the annular bridge 24. The first and second braking contact portions 32 and 34 include oppositely facing outer surfaces that are contacted by brake pads during a braking operation as explained below in more detail.

The annular bridge 24 extends between the first and second annular side walls 20 and 22. The annular bridge 24 has an annular outer surface 24a (i.e., a curved tubular tire engagement surface) that extends between the first and second annular side walls 20 and 22. The annular outer surface 24a is concaved and transversely curved to form an annular tire engagement structure for attaching a pneumatic tire (not shown) thereon.

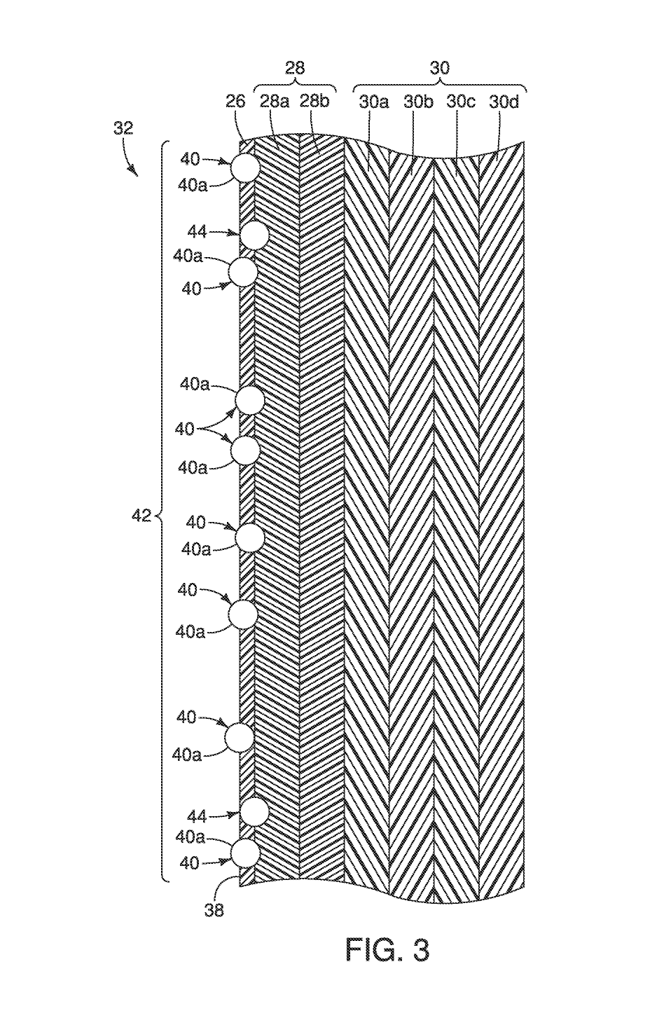

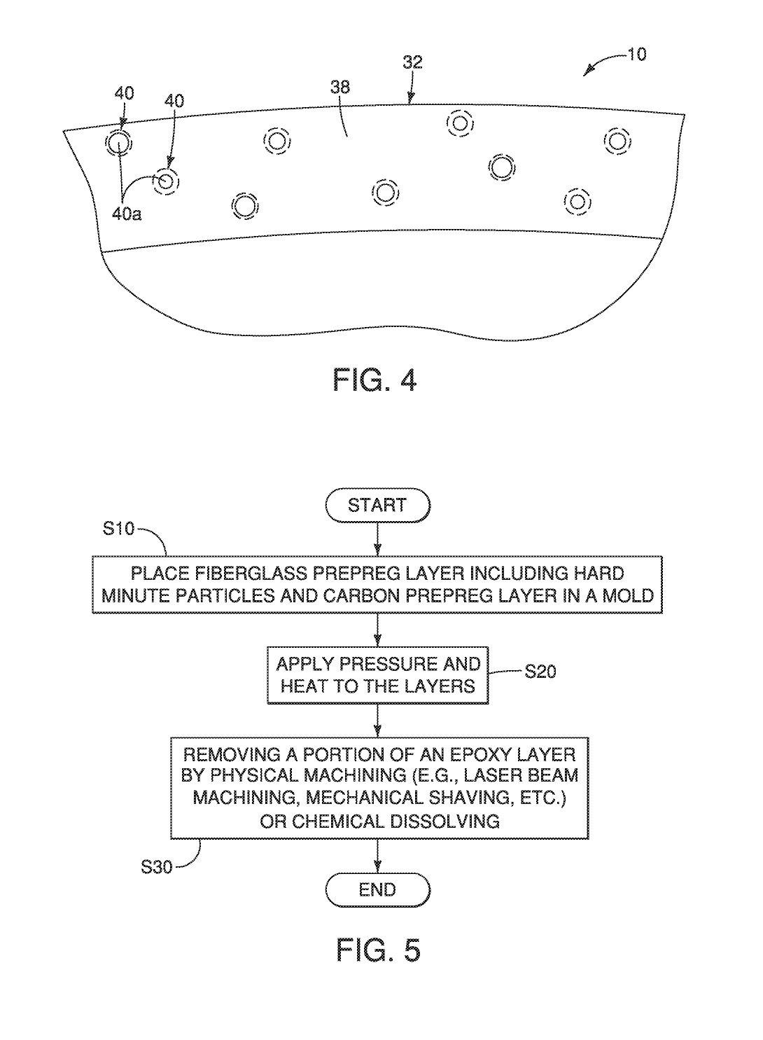

Referring to FIGS. 2 to 4, the first and second braking contact portions 32 and 34 will be described in more detail. The only difference between the first and second braking contact portions 32 and 34 is where the first and second braking contact portions 32 and 34 are disposed. Therefore, only the first braking contact portion 32 will be discussed and illustrated in FIGS. 3 to 4. Since the second braking contact portion 34 is substantially identical to the first braking contact portion 32, the description of the second braking contact portion 34 is omitted for the sake of brevity. It will be apparent to those skilled in the art from this disclosure that the construction of the first braking contact portion 32 as discussed and illustrated herein applies to the construction of the second braking contact portion 34.

As seen in FIGS. 2 to 4, the first braking contact portion 32 has an outermost surface 38 which is defined by the epoxy layer 26. The first braking contact portion 32 also has a plurality of exposed hard particles 40 that are partially embedded in the non-metallic layer (e.g., the epoxy layer 26 and the fiberglass composite layer 28). As explained above, the epoxy layer 26 is disposed directly on the fiberglass composite layer 28. In the first illustrated embodiment, the exposed hard particles 40 are partially embedded in the epoxy layer 26 and the first fiberglass sheet 28a as the non-metallic layer. While most of the exposed hard particles 40 are basically partially embedded in the epoxy layer 26 and the first fiberglass sheet 28a, some of the exposed hard particles 40 may be partially embedded only in the epoxy layer 26.

Each of the exposed hard particles 40 is only partially exposed on the outermost surface 38 of the first braking contact portion 32 so as not to drop off from the outermost surface 38 during braking operation. As seen in FIGS. 3 to 4, each of the exposed hard particles 40 has an exposed surface 40a. Preferably, each of the exposed surfaces 40a is less than 50% of total surface area of each of the exposed hard particles 40 as seen in FIGS. 3 and 4. More preferably, each of the exposed surfaces 40a is less than 20% of total surface area of each of the exposed hard particles 40. Furthermore, each of the exposed surfaces 40a is preferably more than 10% of total surface area of each of the exposed hard particles 40. If the exposed surface 40a is greater than 50% of total surface area of the exposed hard particle 40, then the possibility of the exposed hard particles 40 being detached during a braking operation increases. If the exposed surface 40a is less than 10% of total surface area of the exposed hard particle 40, then effectiveness of the exposed hard particles 40 to increase the coefficient of friction of the outermost surface 38 of the first braking contact portion 32 is minimal. Thus, the preferred range of exposed surface area for the exposed surface 40a is between 10% of total surface area and 50% of total surface area. Of course, depending on the manufacturing techniques and tolerances, it is possible that the composite bicycle rim 12 may include a certain percentage of the exposed hard particles 40 that are not within the preferred range of exposed surface area.

In FIG. 3, for explanation of the exposed hard particles 40, ten hard minute particles 42 are illustrated. Among the ten hard minute particles 42, eight of the hard minute particles 42 that are partially embedded in the epoxy layer 26 and the first fiberglass sheet 28a and are partially exposed on the outermost surface 38 are the exposed hard particles 40. On the other hand, the hard minute particles 42 sometimes include a particle that is not exposed on the outermost surface 38 as illustrated as non-exposed hard particles 44. Since the non-exposed hard particles 44 do not aid in increasing the friction of the first braking contact portion 32, it is preferable that the composite bicycle rim 12 does not include any of the non-exposed hard particles 44.

The hard minute particles 42 will be discussed below in detail. Preferably, the hard minute particles 42 are only located in the areas of the first and second braking contact portions 32 and 34, since including the hard minute particles 42 in other areas serves no purpose and increases the weight and cost of manufacturing the composite bicycle rim 12. Each of the exposed hard particles 40 preferably includes a ceramic material or other suitable hard material that is suitable for a rim braking surface. For example, the ceramic material of the exposed hard particles 40 is silicon carbide (SiC) or chromium oxide (Cr₂O₃).

Referring now to the flow chart of FIG. 5, the processing for forming the first braking contact portion 32 will be described.

The fiberglass composite layer 28 and the carbon composite layer 30 are used to form the first and second braking contact portions 32 and 34. As explained above, the first and second fiberglass sheets 28a and 28b are preferably thin sheets of continuous reinforcement glass fibers that are impregnated with an epoxy resin, which are often called fiberglass prepreg sheets. Likewise, the first, second, third and fourth carbon fiber sheets 30a, 30b, 30c and 30d are preferably thin sheets of continuous reinforcement carbon fibers that are impregnated with epoxy resin, which are often called carbon prepreg sheets. Alternatively, the epoxy resin can be added as a separate component from the fiber sheets

Furthermore, each of the first and second fiberglass sheets 28a and 28b which are used to form the first braking contact portion 32 includes a plurality of hard minute particles which are discussed above as the hard minute particles 42 in FIG. 3. After molding, some of these hard minute particles become the exposed hard particles 40 as shown in FIGS. 3 and 4. Each of the hard minute particles includes ceramic material such as silicon carbide (SiC) or chromium oxide (Cr₂O₃).

In step S10, the fiberglass sheets 28a and 28b of the fiberglass composite layer 28 and the carbon fiber sheets 30a, 30b, 30c and 30d of the carbon composite layer 30 are placed in a mold. In particular, the fiber sheets forming the fiberglass composite layer 28 and the carbon composite layer 30 are accumulated in the mold so that the fiberglass composite layer 28 is placed on the carbon composite layer 30. Preferably, the fiberglass sheet 28a includes the hard minute particles 42 adhered along the areas of the fiberglass sheet 28a that will form the first and second braking contact portions 32 and 34. Alternatively, the hard minute particles 42 could be placed in the mold separately from the fiberglass sheet 28a, FIG. 6 shows that the first fiberglass sheet 28a, the second fiberglass sheet 28b and the first carbon layer 30a are placed in a mold (not shown) while the second, third and fourth carbon fiber sheets 30b, 30c and 30d are not illustrated for the sake of brevity.

When the fiberglass composite layer 28 is placed in the mold, the first and second fiberglass sheets 28a and 28b are accumulated to form layers of unidirectional glass fibers that cross each other. More specifically, the first fiberglass sheet 28a is accumulated on the second fiberglass sheet 28b so that a direction of the unidirectional reinforcing glass fibers of the first fiberglass sheet 28a is approximately perpendicular to a direction of the unidirectional reinforcing glass fibers of the second fiberglass sheet 28b. Likewise, when the carbon composite layer 30 is placed in the mold, the first, second, third and fourth carbon fiber sheets 30a, 30b, 30c and 30d are accumulated so that the two adjacent ones of the first, second, third and fourth carbon fiber sheets 30a, 30b, 30c and 30d have unidirectional carbon fibers that cross each other. For example, the carbon fiber sheet 30a is laminated on the carbon fiber sheet 30b so that a direction of the unidirectional reinforcing carbon fibers of the carbon fiber sheet 30a is approximately perpendicular to a direction of the unidirectional reinforcing carbon fibers of the carbon fiber sheet 30b. Moreover, the carbon fiber sheet 30b is disposed on the carbon fiber sheet 30c so that the direction of the unidirectional reinforcing carbon fibers of the carbon fiber sheet 30b is approximately perpendicular to a direction of the unidirectional reinforcing fibers of the carbon fiber sheet 30c. Furthermore, the carbon fiber sheet 30c is disposed on the carbon fiber sheet 30d so that the direction of the unidirectional reinforcing carbon fibers of the carbon fiber sheet 30c is approximately perpendicular to a direction of the unidirectional reinforcing fibers of carbon fiber sheet 30d.

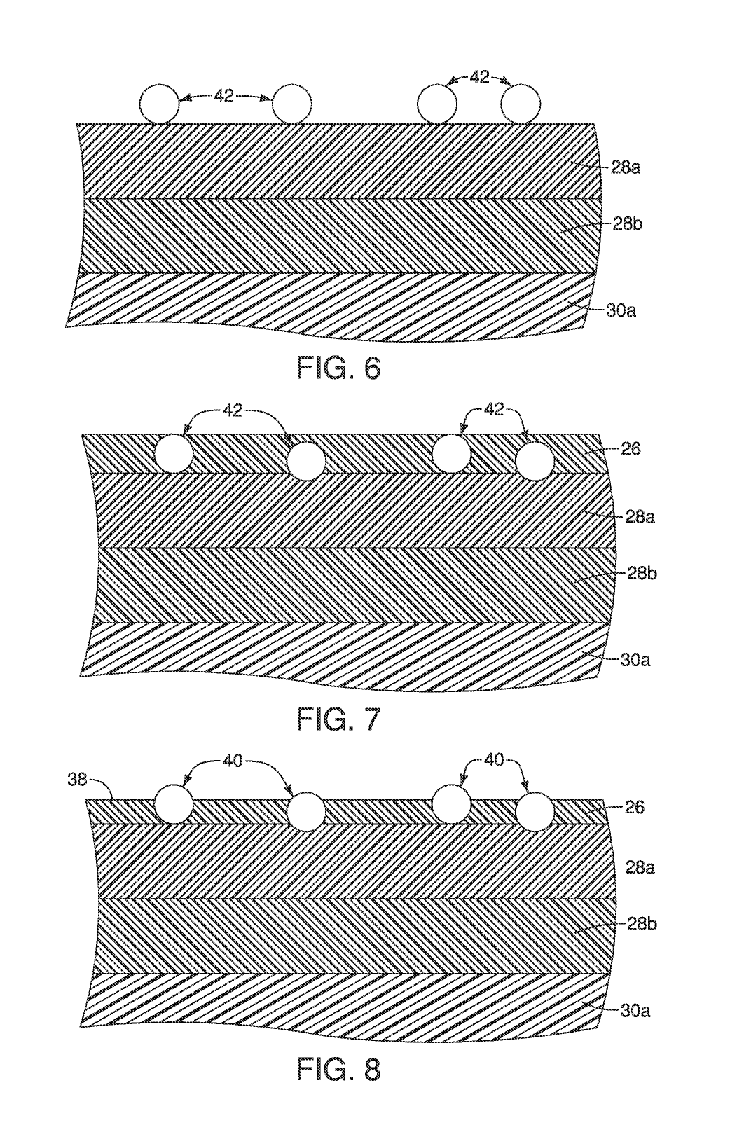

In step S20, pressure and heat are applied to the fiberglass composite layer 28 and the carbon composite layer 30 in the mold. In particular, the pressure and heat are applied from a side of the carbon composite layer 30 to a side of the fiberglass composite layer 28 while an exterior surface of the fiberglass composite layer 28 that is opposite of a surface that contacts the carbon composite layer 30 is pressed against a flat portion of the mold (not shown). The pressure and heat cause the epoxy resin that is included in the fiberglass sheets 28a and 28b of the fiberglass composite layer 28 and the carbon fiber sheets 30a, 30b, 30c and 30d of the carbon composite layer 30 to be melted and cause the fiberglass composite layer 28 and the carbon composite layer 30 to bond together as an integrated one-piece member. Also, the pressure and heat cause the epoxy resin to move toward the exterior surface of the fiberglass composite layer 28 and encapsulate the hard minute particles 42 that are included in the fiberglass sheet 28a of the fiberglass composite layer 28. As a result, as seen in FIG. 7, the epoxy layer 26 is formed to cover the fiberglass composite layer 28, such that the hard minute particles 42 are completely embedded in the epoxy layer 26 and/or the first fiberglass sheet 28a. At this moment, as seen in FIG. 7, each of surfaces of the plurality of hard minute particles 42 basically does not expose from the epoxy layer 26 because of the pressure from the flat portion of the mold. Subsequently, the epoxy layer 26, the fiberglass composite layer 28 and the carbon composite layer 30 in the mold are cooled and demolded. A thickness of the epoxy layer 26 obtained in this step is, for example, about 100 micrometers.

Next, in step S30, a portion of the epoxy layer 26 is removed to form the exposed hard particles 40. In particular, the exposed hard particles 40 are formed by a process of physical machining which is processed by a machine tool to physically operate on the portion of the epoxy layer 26. The term “physical machining” as used herein includes, for example, a laser beam machining, a mechanical shaving, etc. Alternatively, the portion of the epoxy layer 26 may be removed by a process of chemical dissolving. As seen in FIG. 8, after removing the portion of epoxy layer 26, the epoxy layer 26 is thinner than prior to the removal of the portion of the epoxy layer 26 as shown in FIG. 7, and the exposed hard particles 40 are provided. After the portion of the epoxy layer 26 is removed, the thickness of the epoxy layer 26 is, for example, about 90-95 micrometers.

In Figures, the epoxy layer 26, the fiberglass composite layer 28, the carbon composite layer 30 and the exposed hard particles 40 are only schematically illustrated for explanation. Thus, the thicknesses of the epoxy layer 26, the fiberglass composite layer 28, the carbon composite layer 30 with respect to the exposed hard particles 40 are not necessarily to scale with respect to each other.

As explained above, this composite bicycle rim 12 has the first and second braking contact portions 32 and 34 with the plurality of exposed hard particles 40 that are partially embedded in the epoxy layer 26 and the fiberglass composite layer 28, and are partially exposed on the outermost surfaces 38. With this arrangement, when the first and second braking contact portions 32 and 34 are contacted by brake pads of a brake device during a braking operation, the exposed hard particles 40 allow a friction force between the first and second braking contact portions 32 and 34 and the brake pads of the brake device to increase. Accordingly, with this composite bicycle rim 12, brake performance can be improved.

In this embodiment illustrated above, each of the first and second braking contact portions 32 and 34 has the exposed hard particles 40. However, alternatively, the exposed hard particles 40 can be partially exposed on the outermost surface 38 of only one of the first and second braking contact portions 32 and 34.

In this embodiment illustrated above, the fiberglass composite layer 28 is formed of two fiberglass sheets (i.e., the first and second fiberglass sheets 28a and 28b). However, alternatively, the fiberglass composite layer 28 can be formed of only one fiberglass layer if needed and/or desired. Also, alternatively, the composite fiberglass layer 28 can be formed of more than three fiberglass sheets.

In this embodiment illustrated above, the carbon composite layer 30 is formed of the four carbon fiber sheets (i.e., the first, second, third and fourth carbon fiber sheets 30a, 30b, 30c and 30d). However, alternatively, the carbon composite layer 30 can be formed of only one carbon layer or any number of carbon sheets if needed and/or desired.

In this embodiment illustrated above, as shown in FIGS. 1 and 2, the exposed hard particles 40 are disposed in a substantially uniform and substantially continuous manner around the outermost surfaces 38 that constitute the first and second braking contact portions 32 and 34. However, alternatively, the exposed hard particles 40 may be disposed only in selected areas of each of the outermost surfaces 38 that constitute the first and second braking contact portions 32 and 34 such that circumferential areas of the first and second braking contact portions 32 and 34 are devoid of any of the exposed hard particles 40. In this case, it is preferable to provide more exposed hard particles per square meter in those selected areas of the outermost surface 38 than in the first embodiment discussed above.

In this embodiment illustrated above, the composite bicycle rim 12 is a completely non-metallic composite member. However, alternatingly, the composite bicycle rim 12 may be a composite member that includes the non-metallic layer in which the exposed hard particles 40 are embedded and a metallic member.

### Second Embodiment

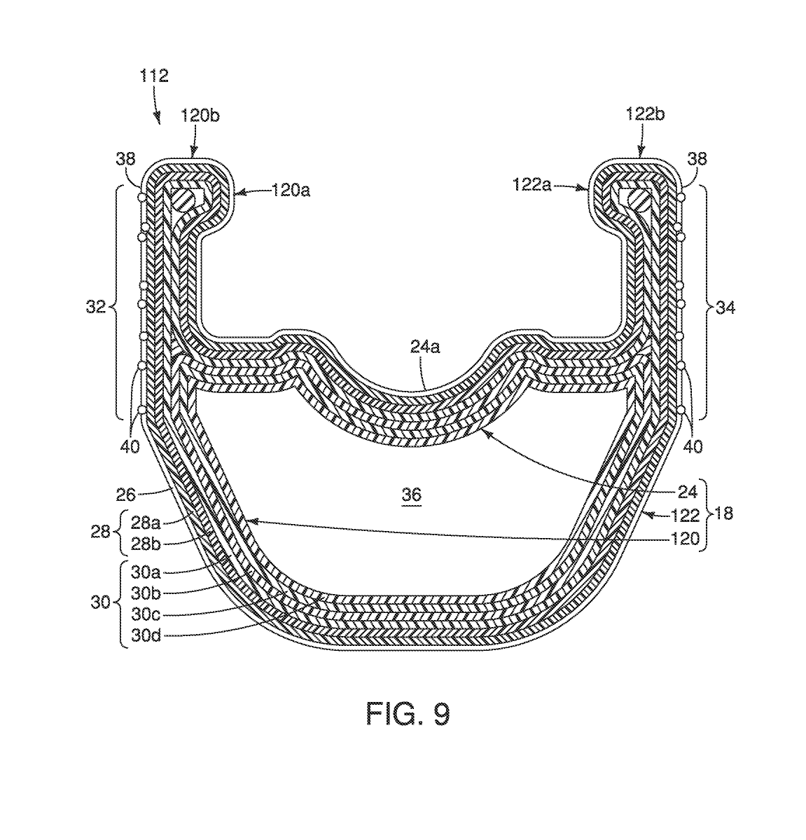

Referring now to FIG. 9, a composite bicycle rim 112 in accordance with a second embodiment will now be explained. The composite bicycle rim 112 is used with the center hub 14 and the spokes 16 to form a bicycle wheel. Basically, the composite bicycle rim 112 in the second embodiment is identical to the first embodiment, and the only difference between the first embodiment and the second embodiment is that the composite bicycle rim 112 has first and second annular side walls 120 and 122 which have clincher portions 120a and 122a, respectively. In particular, the first annular side wall 120 has the clincher portion 120a along an outer peripheral edge 120b for retaining a tire (not shown). Likewise, the second annular side wall 122 has the clincher portion 122a along an outer peripheral edge 122b for retaining a tire (not shown). In view of the similarity between the first and second embodiments, the parts of the second embodiment that are identical to the parts of the first embodiment and functionally identical (but not exactly identical) to the parts of the first embodiment will be given the same reference numerals as the parts of the first embodiment. Moreover, the second embodiment is identical to the first embodiment in that the first annular side wall 120 includes the first braking contact portion 32, the second annular side wall 122 includes the second braking contact portion 34, and at least one of the first and second braking contact portions 32 and 34 has the exposed hard particles 40. Accordingly, the descriptions of the parts of the second embodiment that are identical to the parts of the first embodiment and functionally identical (but not exactly identical) to the parts of the first embodiment may be omitted for the sake of brevity.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. Also it will be understood that although the terms first and second may be used herein to describe various components these components should not be limited by these terms. These terms are only used to distinguish one component from another. Thus, for example, a first component discussed above could be termed a second component and vice-a-versa without departing from the teachings of the present invention. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired so long as they do not substantially their intended function. Components that are shown directly connected or contacting each other can have intermediate structures disposed between them unless specifically stated otherwise. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A composite bicycle rim comprising:
a first annular side wall including a first braking contact portion;
a second annular side wall including a second braking contact portion; and
an annular bridge extending between the first and second annular side walls;
at least one of the first and second braking contact portions having a plurality of exposed hard particles partially embedded in a non-metallic layer, the exposed hard particles being partially exposed on an outermost surface of the at least one of the first and second braking contact portions.

2. The composite bicycle rim according to claim 1, wherein
the exposed hard particles are exposed on the outermost surface of the at east one of the first and second braking contact portions by a process of physical machining.

3. The composite bicycle rim according to claim 2, wherein
the process of physical machining includes a process of laser beam machining.

4. The composite bicycle rim according to claim 2, wherein
the process of physical machining includes a process of mechanical shaving.

5. The composite bicycle rim according to claim 1, wherein
the exposed hard particles are exposed on the outermost surface of the at least one of the first and second braking contact portions by a process of chemical dissolving.

6. The composite bicycle rim according to claim 1, wherein
both of the first and second braking contact portions have the exposed hard particles.

7. The composite bicycle rim according to claim 1, wherein
each of the exposed hard particles has an exposed surface, each of the exposed surfaces is less than 50% of total surface area of each of the exposed hard particles.

8. The composite bicycle rim according to claim 7, wherein
each of the exposed surfaces is less than 20% of total surface area of each of the exposed hard particles.

9. The composite bicycle rim according to claim 1, wherein
each of the exposed hard particles includes ceramic material.

10. The composite bicycle rim according to claim 9, wherein
the ceramic material is silicon carbide.

11. The composite bicycle rim according to claim 9, wherein
the ceramic material is chromium oxide.

12. The composite bicycle rim according to claim 1, wherein
the non-metallic layer of the at least one of the first and second braking contact portions includes an epoxy layer defining the outermost surface of the at least one of the first and second braking contact portions.

13. The composite bicycle rim according to claim 12, wherein
each of the exposed hard particles is partially disposed in the epoxy layer.

14. The composite bicycle rim according to claim 12, wherein
the non-metallic layer further includes a fiberglass layer, the epoxy layer being disposed directly on the fiberglass layer.

15. The composite bicycle rim according to claim 14, wherein
each of the exposed hard particles is partially disposed in the epoxy layer.

16. The composite bicycle rim according to claim 15, wherein
the exposed hard particles are further partially disposed in the fiberglass layer.

17. The composite bicycle rim according to claim 1, wherein
the annular bridge has a curved tubular tire engagement surface extending between the first and second annular side walls.

18. The composite bicycle rim according to claim 1, wherein
each of the first and second annular side walls has a clincher portion along an outer peripheral edge.
